(19) United States
(12) Patent Application Publication
(10) Pub. No.: US 2024/0005264 A1
(43) Pub. Date: Jan. 4, 2024

(54) DELIVERY SUPPORT APPARATUS, DELIVERY SUPPORT METHOD, AND DELIVERY SUPPORT PROGRAM

(71) Applicant: Nippon Telegraph and Telephone Corporation, Tokyo (JP)

(72) Inventors: Manami OGAWA, Musashino-shi, Tokyo (JP); Shunsuke KANAI, Musashino-shi, Tokyo (JP); Kazuaki AKASHI, Musashino-shi, Tokyo (JP); Shohei NISHIKAWA, Musashino-shi, Tokyo (JP)

(21) Appl. No.: 18/265,127

(22) PCT Filed: Dec. 3, 2020
(86) PCT No.: PCT/JP2020/045017

§ 371 Date: Jun. 2, 2023

(51) Int. Cl. G06Q 10/0835

(52) U.S. Cl. CPC G06Q 10/08355

(57) ABSTRACT

A delivery support device includes a probability calculation unit that calculates probabilities that a delivery vehicle arrives at a plurality of respective target positions on the basis of positional relationships between a departure position of the delivery vehicle and the plurality of respective target positions and an amount of fuel before the delivery vehicle departs, and an expected value calculation unit that calculates an expected value of a number of target positions where the delivery vehicle arrives on the basis of probabilities for the plurality of respective target positions.

### TECHNICAL FIELD

An embodiment described herein relates to a delivery support device, a delivery support method, and a delivery support program.

### BACKGROUND ART

A delivery vehicle is one of main means for supplying supplies to a delivery destination.

A problem of appropriately determining a delivery route of a delivery vehicle in order to efficiently deliver supplies to a plurality of delivery destinations is a problem of high interest. For example, it is known that a problem of delivering supplies to as many delivery destinations as possible using as few delivery vehicles as possible among a plurality of delivery vehicles disposed in different delivery bases can be regarded as a sensor disposition problem.

The sensor disposition problem is considered to belong to a class NP (non-deterministic polynomial time). Therefore, in a case where there are many delivery destinations, a strict solution is difficult to be obtained within appropriate calculation time. As a method for obtaining an approximate solution to such a problem, a greedy method is known. According to the greedy method, the number of delivery destinations to which a delivery vehicle that has departed from a certain delivery base can deliver supplies is calculated. As a result, how many delivery destinations supplies can be delivered to when the delivery vehicle is caused to depart from which delivery base can be estimated.

On the other hand, the number of delivery destinations to which a delivery vehicle can deliver supplies changes according to the delivery route. For example, in a case where it is desired to suppress the fuel consumption, the delivery route of the delivery vehicle is determined such that the moving distance is minimized. As a method for generating a delivery route in which the moving distance is minimized, various methods have been proposed.

### CITATION LIST

### Patent Literature

Patent Literature 1: JP 2001-34880 A
Patent Literature 2: JP 2010-39961 A

### SUMMARY OF INVENTION

### Technical Problem

However, there are few methods for generating a delivery route for a purpose other than minimizing the moving distance. For this reason, in a case where an action purpose of a delivery vehicle includes a purpose other than minimizing the moving distance, how many delivery destinations supplies can be delivered to when the delivery vehicle is caused to depart from which delivery base is difficult to be estimated. Therefore, a supply delivery plan is difficult to efficiently prepared.

The present invention has been made in view of the above circumstances, and an object thereof is to provide a means for efficiently preparing a supply delivery plan.

### Solution to Problem

A delivery support device of one aspect includes a probability calculation unit that calculates probabilities that a delivery vehicle arrives at a plurality of respective target positions on the basis of positional relationships between a departure position of the delivery vehicle and the plurality of respective target positions and an amount of fuel before the delivery vehicle departs, and an expected value calculation unit that calculates an expected value of a number of target positions where the delivery vehicle arrives on the basis of probabilities for the plurality of respective target positions.

### Advantageous Effects of Invention

According to an embodiment, a means for efficiently planning a supply delivery plan can be provided.

### BRIEF DESCRIPTION OF DRAWINGS

FIG. 1 is a schematic diagram illustrating an example of a configuration of a delivery system according to the embodiment.

FIG. 2 is a block diagram illustrating an example of a hardware configuration of a delivery support device according to the embodiment.

FIG. 3 is a block diagram illustrating an example of a functional configuration of the delivery support device according to the embodiment.

FIG. 4 is a conceptual diagram illustrating an example of a configuration of delivery vehicle information according to the embodiment.

FIG. 5 is a conceptual diagram illustrating an example of a configuration of delivery destination information according to the embodiment.

FIG. 6 is a conceptual diagram illustrating an example of a configuration of movement range information according to the embodiment.

FIG. 7 is a flowchart illustrating an example of delivery support operation in the delivery support device according to the embodiment.

FIG. 8 is a schematic diagram illustrating an example of classification of delivery destinations in a case where a first movement range is applied in the delivery support operation in the delivery support device according to the embodiment.

FIG. 9 is a schematic diagram illustrating an example of classification of delivery destinations in a case where a second movement range is applied in the delivery support operation in the delivery support device according to the embodiment.

FIG. 10 is a schematic diagram illustrating an example of classification of delivery destinations in a case where a third movement range is applied in the delivery support operation in the delivery support device according to the embodiment.

### DESCRIPTION OF EMBODIMENTS

Hereinafter, an embodiment will be described with reference to the drawings. Note that, in the following description, components having the same function and configuration are denoted by common reference signs. Furthermore, in a case where a plurality of components having common reference signs is distinguished, the components are distinguished by a further reference sign attached after the common reference signs (for example, hyphen and number such as “−1”)

### 1. Embodiment

### 1.1 Configuration

A configuration of a delivery system according to the embodiment will be described.

### 1.1.1 Overall Configuration

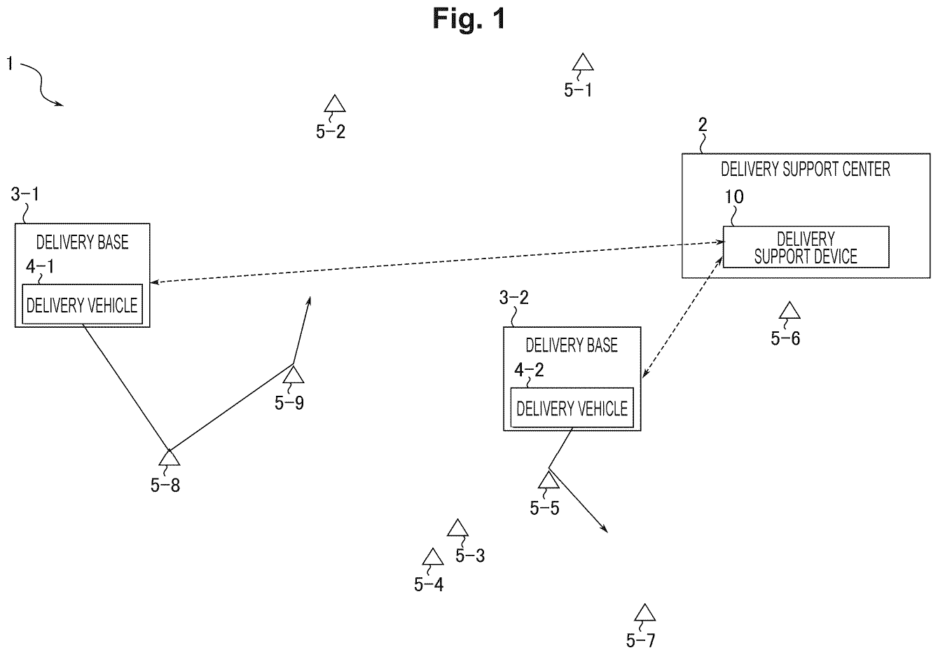

First, the configuration of the delivery system according to the embodiment will be described. FIG. 1 is a block diagram illustrating an example of the configuration of the delivery system according to the embodiment.

As illustrated in FIG. 1, a delivery system 1 is a system for supplying supplies into a certain region using a plurality of delivery vehicles 4-1 and 4-2. The delivery system 1 includes a delivery support center 2, a plurality of delivery bases 3-1 and 3-2, and a plurality of delivery destinations 5-1, 5-2, 5-3, 5-4, 5-5, 5-6, 5-7, 5-8, and 5-9.

Hereinafter, in a case where each of the plurality of delivery bases 3-1 and 3-2 is not distinguished, each of the plurality of delivery bases 3-1 and 3-2 may be referred to as a “delivery base 3”. In a case where each of the plurality of delivery vehicles 4-1 and 4-2 is not distinguished, each of the plurality of delivery vehicles 4-1 and 4-2 may be referred to as a “delivery vehicle 4”. In a case where each of the plurality of delivery destinations 5-1 to 5-9 is not distinguished, each of the plurality of delivery destinations 5-1 to 5-9 may be referred to as a “delivery destination 5”.

The delivery support center 2 generates a delivery plan for comprehensively controlling delivery of supplies in the delivery system 1. The delivery support center 2 is wirelessly connected to the delivery bases 3. As a result, the delivery support center 2 wirelessly transmits the generated delivery plan to the delivery bases 3.

Furthermore, the delivery support center 2 also includes a delivery support device 10. The delivery support device 10 is a computer that supports generation of a delivery plan in the delivery support center 2. Details of the delivery support device 10 will be described below.

At least one delivery vehicle 4 is disposed in a delivery base 3. In an example of FIG. 1, a case where the delivery vehicles 4-1 and 4-2 are disposed in the delivery bases 3-1 and 3-2, respectively, is illustrated. Furthermore, supplies to be delivered to the delivery destinations 5 are stored in the delivery bases 3. The delivery bases 3 instruct the delivery vehicles 4 to depart on the basis of a delivery plan received from the delivery support center 2.

The delivery vehicles 4 deliver supplies in the delivery bases 3 where the delivery vehicles 4 are disposed to the delivery destinations 5 according to various action purposes. The action purposes of the delivery vehicles 4 may be different for each of the delivery vehicles 4. The action purposes of the delivery vehicles 4 can be different even for the same delivery vehicles 4 each time the delivery vehicles 4 depart from the delivery bases 3. Furthermore, the action purposes of the delivery vehicles 4 can be changed during delivery. The action purposes of the delivery vehicles 4 include, for example, minimizing the moving distance, not delaying the designated arrival time, and any other action purposes.

The delivery destinations 5 are destinations to which supplies are delivered by the delivery vehicles 4. The delivery destinations 5 are disposed in a region covered by the delivery system 1.

### 1.1.2 Delivery Support Device

Next, a configuration of the delivery support device according to the embodiment will be described.

(Hardware Configuration)

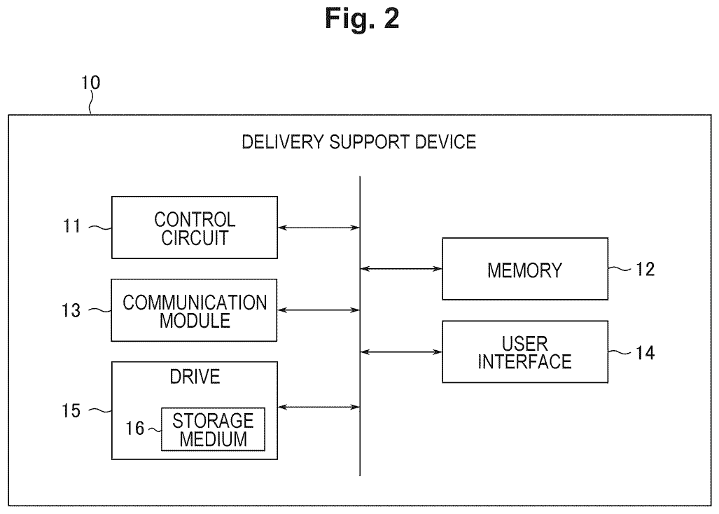

FIG. 2 is a block diagram illustrating an example of a hardware configuration of the delivery support device according to the embodiment. As illustrated in FIG. 2, the delivery support device 10 includes a control circuit 11, a memory 12, a communication module 13, a user interface 14, and a drive 15.

The control circuit 11 is a circuit that entirely controls each component of the delivery support device 10. The control circuit 11 includes a central processing unit (CPU), a random access memory (RAM), a read only memory (ROM), and the like.

The memory 12 is an auxiliary storage device of the delivery support device 10. The memory 12 includes, for example, a hard disk drive (HDD), a solid state drive (SSD), a memory card, and the like. The memory 12 stores various types of information used for delivery support operation and a delivery support program. A delivery support management program can be stored in the memory 12 by being transmitted from the outside of the delivery support device 10 via a network (not illustrated).

The delivery support operation is a series of types of operation performed to support generation of a supply delivery plan in the delivery system 1. The delivery support operation includes, for example, operation for estimating an expected value of how many delivery destinations 5 supplies can be delivered to when a delivery vehicle 4 disposed in which delivery base 3 is caused to depart. The delivery support program is a program for causing the delivery support device 10 to perform the delivery support operation. Details of the delivery support operation will be described below.

The communication module 13 is a circuit used for transmission and reception of data via a network. The communication module 13 is constructed in conformity with, for example, Ethernet (registered trademark).

The user interface 14 is a circuit for communicating information between a user and the control circuit 11. The user interface 14 includes an input device and an output device. The input device includes, for example, a touch panel, an operation button, and the like. The output device includes, for example, a liquid crystal display (LCD), an electroluminescence (EL) display, and a printer. The user interface 14 converts input from a user (user input) into an electrical signal, and then transmits the electrical signal to the control circuit 11. The user interface 14 outputs performance result of the delivery support program received from the control circuit 11 to the user.

The drive 15 is a device for reading a program stored in a storage medium 16. The drive 15 includes, for example, a compact disk (CD) drive, a digital versatile disk (DVD) drive, and the like.

The storage medium 16 is a medium that accumulates information such as programs by electrical, magnetic, optical, mechanical, or chemical action. The storage medium 16 may store the delivery support program.

(Functional Configuration)

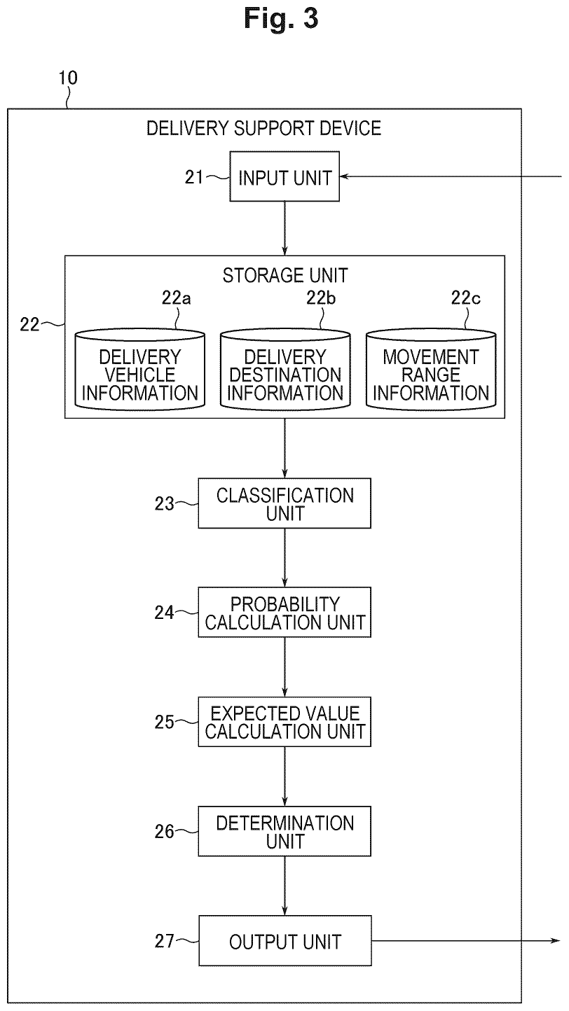

FIG. 3 is a block diagram illustrating an example of a functional configuration of the delivery support device according to the embodiment.

The CPU of the control circuit 11 deploys the delivery support program stored in the memory 12 or the storage medium 16 in the RAM. Then, the CPU of the control circuit 11 controls components 12 to 15 by interpreting and performing the delivery support program deployed in the RAM. As a result, as illustrated in FIG. 3, the delivery support device 10 functions as a computer including an input unit 21, a storage unit 22, a classification unit 23, a probability calculation unit 24, an expected value calculation unit 25, a determination unit 26, and an output unit 27.

The input unit 21 stores various types of information in the storage unit 22 on the basis of input from a user. The various types of information stored in the storage unit 22 include, for example, delivery vehicle information 22a, delivery destination information 22b, and movement range information 22c.

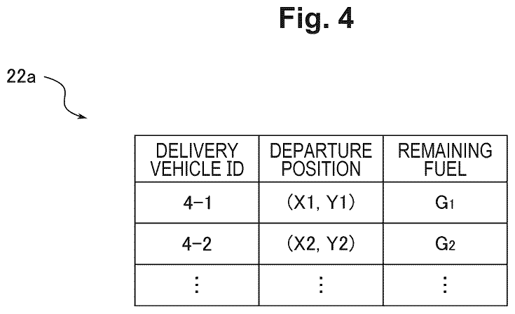

FIGS. 4 to 6 are conceptual diagrams illustrating examples of configurations of delivery vehicle information, delivery destination information, and movement range information according to the embodiment, respectively.

As illustrated in FIG. 4, the delivery vehicle information 22a is information of the delivery vehicles 4 in a state of standby in the delivery bases 3. Specifically, the delivery vehicle information 22a includes information of delivery vehicle IDs, departure positions, and remaining fuel.

The delivery vehicle IDs uniquely identify the delivery vehicles 4.

The departure positions are position information of the delivery bases 3 where the delivery vehicles 4 are on standby. The departure positions are represented by, for example, two-dimensional coordinates (X, Y). The departure positions may be represented by longitude and latitude.

The remaining fuel indicates the amounts of fuel loaded into the delivery vehicles 4. The delivery vehicles 4 can deliver supplies to the delivery destinations 5 within a range of the remaining fuel.

In the example of FIG. 4, the delivery support device 10 can grasp, from the delivery vehicle information 22a, that the delivery vehicle 4-1 is on standby at a departure position (X1, Y1) having remaining fuel G₁, and that the delivery vehicle 4-2 is on standby at a departure position (X2, Y2) having remaining fuel G₂.

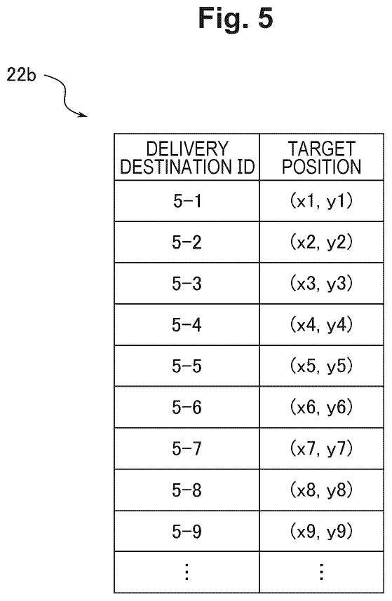

As illustrated in FIG. 5, the delivery destination information 22b is information of the delivery destinations 5 waiting for delivery of supplies. Specifically, the delivery destination information 22b includes information of delivery destination IDs and target positions.

The delivery destination IDs uniquely identify the delivery destinations 5.

The target positions are position information of the delivery destinations 5. The target positions are represented by, for example, two-dimensional coordinates (x, y). The target positions may be represented by longitude and latitude, similarly to the departure positions.

In the example of FIG. 5, the delivery support device 10 can grasp, from the delivery destination information 22b, that the delivery destinations 5-1 to 5-9 are located at target positions (x1, y1) to (x9, y9), respectively.

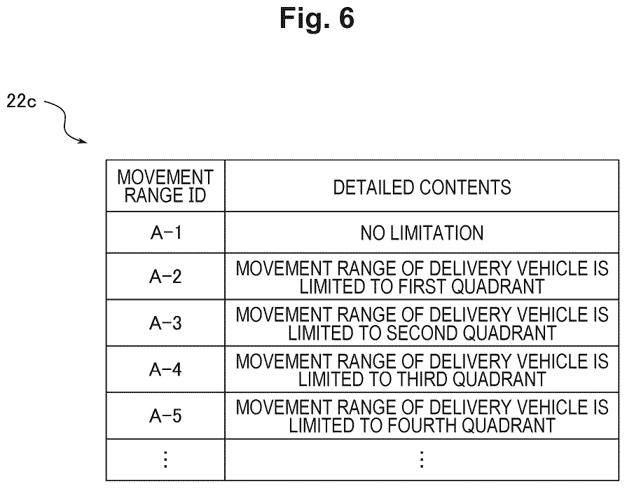

As illustrated in FIG. 6, the movement range information 22c is information for defining ranges in which the delivery vehicles 4 move. Specifically, the movement range information 22c includes movement range IDs and information of detailed contents.

The movement range IDs uniquely identify ranges in which the delivery vehicles 4 move at the time of delivery of supplies.

The detailed contents are specific description of movement ranges of the delivery vehicles 4. In the detailed contents, for example, ranges in which the delivery vehicles 4 can move are described using departure positions of the respective delivery vehicles 4 as the origins.

In the example of FIG. 6, the delivery support device 10 can select, from the movement range information 22c, a case (A-1) where there is no limitation and cases (A-2) to (A-5) where there is limitation to a first quadrant to a fourth quadrant having the departure positions as the origins as the movement ranges of the respective delivery vehicles 4.

Returning to FIG. 3, the functional configuration of the delivery support device 10 will be described.

The classification unit 23 selects a delivery vehicle 4 and a movement range on the basis of the delivery vehicle information 22a and the movement range information 22c. Assuming a case where the selected delivery vehicle 4 moves according to the selected movement range, the classification unit 23 classifies all the delivery destinations 5 into one of three regions R₁ to R₃ on the basis of the delivery destination information 22b. The classification unit 23 transmits classification result to the probability calculation unit 24.

The regions R₁ to R₃ are defined on the basis of whether or not the selected delivery vehicle 4 can deliver supplies. Specifically, a region R₁ indicates a region where the selected delivery vehicle 4 can reliably deliver supplies according to any action purpose. A region R₂ is a region from which the region R₁ is excluded and indicates a region in which the selected delivery vehicle 4 is likely to deliver supplies depending on the action purpose. A region R₃ indicates a region where the selected delivery vehicle 4 cannot reliably deliver supplies according to any action purpose.

Note that, in classification into any of the regions R₁ to R₃, the classification unit 23 does not assume that the delivery vehicle 4 delivers supplies according to a specific action purpose. In other words, the classification unit 23 classifies all the delivery destinations 5 into one of the three regions R₁ to R₃ in consideration that the delivery vehicle 4 takes an action purpose other than minimizing the moving distance.

More specifically, the classification unit 23 determines the regions R₁ to R₃ according to following Formulas (1) to (3).

[Math. 1]

dⱼ∈R₁ [symbol] 2Σ_{d}_{ⱼ}_{∈R}_{₁}gⱼ≤Gᵢ (1)

dⱼ∈R₂ [symbol] dⱼ∉R₁\hat{ }≤2gⱼGᵢ (2)

dⱼ∈R₃ [symbol] 2gⱼ>Gᵢ (3)

Here, remaining fuel Gᵢ is the amount of remaining fuel of a delivery vehicle 4-i (i is an integer of 1 or more). A position dⱼ indicates a positional relationship between a departure position of the delivery vehicle 4-i and a target position of a delivery destination 5-j (j is an integer of 1 or more). Fuel consumption gⱼ is the amount of fuel consumed when the delivery vehicle 4-i moves to the position dⱼ.

Note that the classification unit 23 may determine the region R₁ not according to Formula (1) but according to Formula (1)′.

[Math. 2]

dⱼ∈R₁ [symbol] (2Σ_{d}_{ⱼ}_{∈R}_{₁}gⱼ)−g_{j*}≤Gᵢ (1)

Here, fuel consumption g_{j*} is the amount of fuel consumed when the delivery vehicle 4-i moves from the departure position of the delivery vehicle 4-i to the delivery destination farthest from the departure position in the region R₁.

The probability calculation unit 24 calculates probabilities that the delivery vehicle 4-i arrives at the respective delivery destinations 5 on the basis of classification result by the classification unit 23. The probability calculation unit 24 transmits the probabilities calculated for the respective delivery destinations 5 to the expected value calculation unit 25.

Specifically, the probability calculation unit 24 calculates probabilities corresponding to all delivery destinations 5 classified into the region R₁ as 100%. The probability calculation unit 24 calculates probabilities corresponding to all delivery destinations 5 classified into the region R₂ such that the probabilities are values of more than 0% and less than 100%. The probability calculation unit 24 calculates probabilities corresponding to all delivery destinations 5 classified into the region R₃ as 0%.

More specifically, the probability calculation unit 24 calculates a probability Pr (j) corresponding to the delivery destination 5-j classified into the region R₂ on the basis of following Formula (4). The probability Pr (j) can also be said to be a probability that the delivery vehicle 4-i arrives at the delivery destination 5-j in a case where supplies are delivered to the delivery destination 5-j classified into the region R₂ after supplies are delivered to all the delivery destinations 5 classified into the region R₁.

$$\\ \begin{matrix}[ Math . 3 ] & \\ Pr ( j ) = \frac{1}{2} ( 1 + {erf}^{( {G}_{i} - gg - μ )} / \sqrt{2 σ} ) & ( 4 )\end{matrix}$$

Here, a function erf is a sigmoid function. Fuel gg is an approximate value of the amount of fuel consumed when supplies are delivered to all the delivery destinations 5 classified into the region R₁. An average value p and a standard deviation a are, respectively, an average value and a standard deviation in a case where probability distribution of the amount of fuel consumed due to movement to a certain delivery destination 5 classified into the region R₂ after supplies are delivered to all the delivery destinations 5 classified into the region R₁ is approximated by normal distribution. It is assumed that the average value p and the standard deviation a are, respectively, expressed as following Formulas (5) and (6) using values y and z, for example.

[Math. 4]

μ=(2y+2z)/2=y+z (5)

σ=(μ−2y)4=(z−y)/4 (6)

The values y and z are, respectively, the minimum value and the maximum value of the amount of fuel consumed due to one-way movement to a certain delivery destination 5 classified into the region R₂ after supplies are delivered to all the delivery destinations 5 classified into the region R₁. As a result, a probability that values according to normal distribution (μ, σ) exceed values 2y and 2z can be made negligibly small.

The expected value calculation unit 25 calculates an expected value of the number of delivery destinations 5 to which supplies are delivered in a case where the selected delivery vehicle 4-i moves within the selected movement range on the basis of probabilities for the respective delivery destinations 5. The expected value calculation unit 25 transmits the calculated expected value to the determination unit 26. Specifically, the expected value calculation unit 25 calculates an expected value N (i, k) in a case where the delivery vehicle 4-i moves in a range having a movement range ID of A-k on the basis of following Formula (7).

[Math. 5]

N(i,k)=ΣPr(j) (7)

The determination unit 26 receives expected values N (i, k) for respective movement ranges from the expected value calculation unit 25. The determination unit 26 determines the maximum value of the expected values and a movement range having the maximum expected value in the same delivery vehicle 4-i. The determination unit 26 transmits a set of the maximum value of the expected values and the movement range having the maximum expected value to the output unit 27.

The output unit 27 outputs the set of the maximum value of the expected values and the movement range having the maximum expected value to a user.

The above configuration allows a user to obtain the maximum value of an expected value of the number of delivery destinations 5 to which supplies are delivered by one delivery vehicle 4 and a movement range from the delivery support device 10 as information for supporting a delivery plan. Then, the user can generate a delivery plan on the basis of the information.

### 1.2. Operation

Next, operation of the delivery support device according to the embodiment will be described.

### 1.2.1 Delivery Support Operation

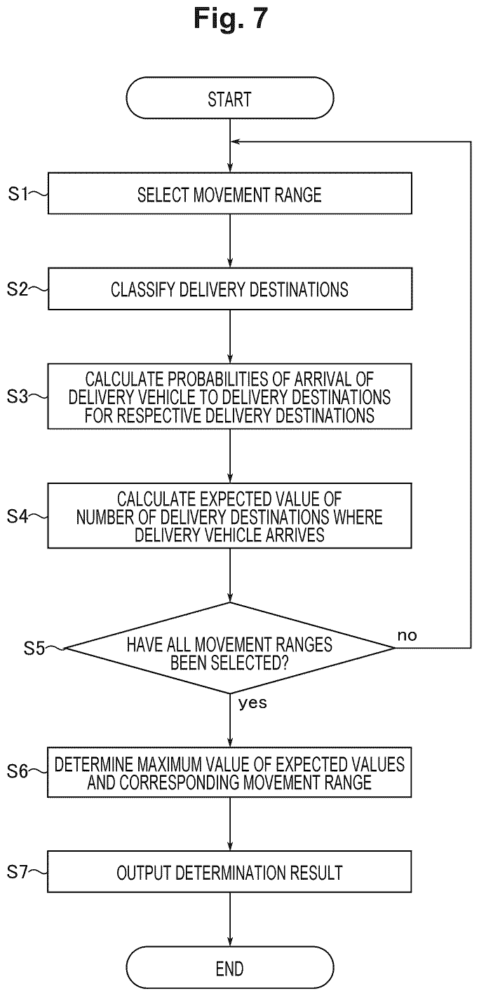

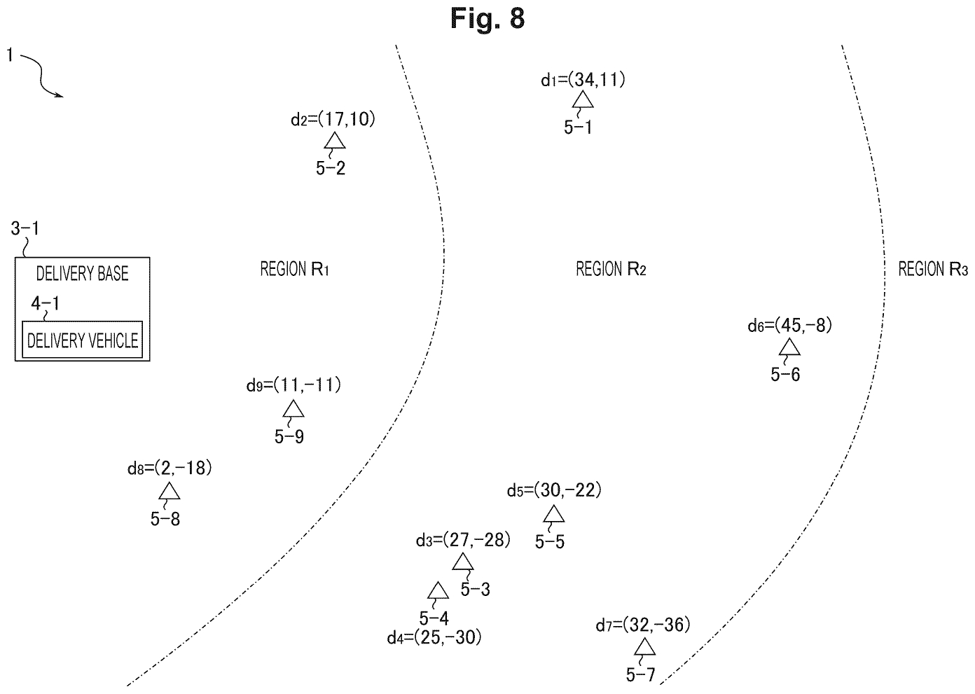

FIG. 7 is a flowchart illustrating an example of the delivery support operation in the delivery support device according to the embodiment. FIGS. 8 to 10 are schematic diagrams illustrating examples of classification of delivery destinations in a case where a first movement range to a third movement range are applied in the delivery support operation in the delivery support device according to the embodiment. The first movement range corresponds to a case where there is no limitation on a movement range (movement range ID: A-1). The second movement range corresponds to a case where a movement range is limited to the first quadrant (movement range ID: A-2). The third movement range corresponds to a case where a movement range is limited to the fourth quadrant (movement range ID: A-5).

In the example of FIG. 7, it is assumed that the delivery vehicle information 22a, the delivery destination information 22b, and the movement range information 22c are stored in the memory 12 in advance by user input. Furthermore, in the following delivery support operation, a case where the delivery vehicle 4-1 is selected will be described as an example (i=1).

As illustrated in FIG. 7, when the delivery vehicle 4-1 is selected on the basis of the delivery vehicle information 22a (start), the classification unit 23 selects a movement range from the movement range information 22c (S1). For example, the classification unit 23 first selects a case where there is no limitation on the movement range (k=1).

After the movement range is selected, the classification unit 23 classifies the delivery destinations 5-1 to 5-9 into any of the regions R₁ to R₃ (S2).

Specifically, the classification unit 23 calculates positions dⱼ=(X1-xj, Y1-yj) from the departure position to all the delivery destinations 5-1 to 5-9. In the example of FIG. 8, positions dᵢ to d₉ are as follows. d₁=(34, 11), d₂=(17, 10), d₃=(27, −28), d₄=(25, −30), de (30, −22), d₆=(45, −8), d₇=(32, −36), d₈=(2-18), and d₉=(11, −11).

Subsequently, the classification unit 23 calculates fuel consumption gⱼ. For convenience of description, assuming that the fuel consumption gⱼ is equal to the distances to the positions dⱼ, fuel consumption g₁ to g₉ are as follows. g₁=35.73, g₂=19.72, g₃=38.89, g₄=39.05, g₅=37.20, g₆=45.70, g₁=48.16, g₈=18.11, and g₉=15.55.

Subsequently, the classification unit 23 identifies delivery destinations 5 that belong to the region R₁ according to Formula (1) or (1)′. In the example of FIG. 8, the classification unit 23 classifies delivery destinations 5-9, 5-8, and 5-2 into the region R₁ according to Formula (1)′. Among the delivery destinations 5 that belong to the region R₁, the delivery destination 5-2 is the delivery destination farthest from the departure position of the delivery vehicle 4-1 in the region R₁.

Subsequently, the classification unit 23 identifies delivery destinations 5 that belong to the regions R₂ and R₃ according to Formulas (2) and (3). In the example of FIG. 8, the classification unit 23 classifies all remaining delivery destinations 5-1, 5-5, 5-3, 5-4, 5-6, and 5-7 into the region R₂. The classification unit 23 does not classify any delivery destination into the region R₃.

After classification for all the delivery destinations 5 is completed, the probability calculation unit 24 calculates delivery probabilities for the respective delivery destinations 5 (S3).

Specifically, the probability calculation unit 24 calculates “1” as probabilities Pr (9), Pr (8), and Pr (2) of the delivery destinations 5-9, 5-8, and 5-2 classified into the region R₁. Furthermore, the probability calculation unit 24 calculates probabilities Pr (1), Pr (5), Pr (3), Pr (4), Pr (6), and Pr (7) of the delivery destinations 5-1, 5-5, 5-3, 5-4, 5-6, and 5-7 classified into the region R₂ on the basis of Formula (4). For convenience of description, assuming that remaining fuel G₁=100 and fuel gg=42.71, the probabilities Pr (1), Pr (5), Pr (3), Pr (4), Pr (6), and Pr (7) are as follows. Pr (1)=0.327, Pr (5)=0.599, Pr (3)=0.089, Pr (4)=0.049, Pr (6)=5.86*10⁻⁴, and Pr (7)=7.86*10⁻¹⁰.

After calculation of the probabilities corresponding to all the delivery destinations 5 is completed, the expected value calculation unit 25 calculates an expected value corresponding to the selected movement range (S4). Specifically, the expected value calculation unit 25 calculates an expected value N (1, 1)=4.06 according to Formula (7).

After calculating the expected value for one movement range, the delivery support device 10 determines whether or not all movement ranges have been selected (S5).

In a case where there is an unselected movement range (S5; no), the processing proceeds to S1. As a result, processing of S1 to S5 is repeated until expected values for all the movement ranges are calculated.

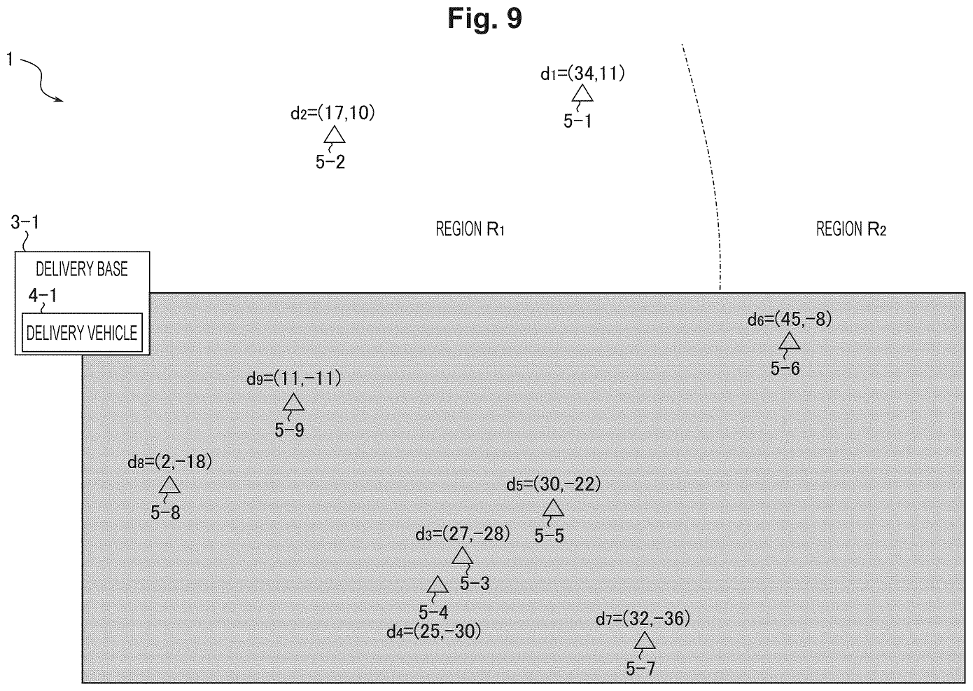

Specifically, for example, in a case where the movement range is limited to the first quadrant in processing of S1 (S1; k=2), the classification unit 23 considers only delivery destinations 5-1 and 5-2 located in the first quadrant with respect to the delivery base 3-1 among the delivery destinations 5-1 to 5-9. As a result, as illustrated in FIG. 9, the classification unit 23 classifies both the delivery destinations 5-2 and 5-1 into the region R₁ according to Formula (1) or (1)′. The classification unit 23 does not classify any delivery destination into the region R₂ and the region R₃.

Accordingly, the probability calculation unit 24 calculates “1” as probabilities Pr (2) and Pr (1) of the delivery destinations 5-2 and 5-1 classified into the region R₁. Therefore, the expected value calculation unit 25 calculates an expected value N (1, 2)=2.0 according to Formula (7).

Furthermore, for example, in the processing of S1, in a case where the movement range is limited to the second quadrant or the third quadrant (S1; k=3 or k=4), the classification unit 23 does not consider all of the delivery destinations 5-1 to 5-9. Therefore, the expected value calculation unit 25 calculates an expected value N (1, 3)=N (1, 4)=0.0.

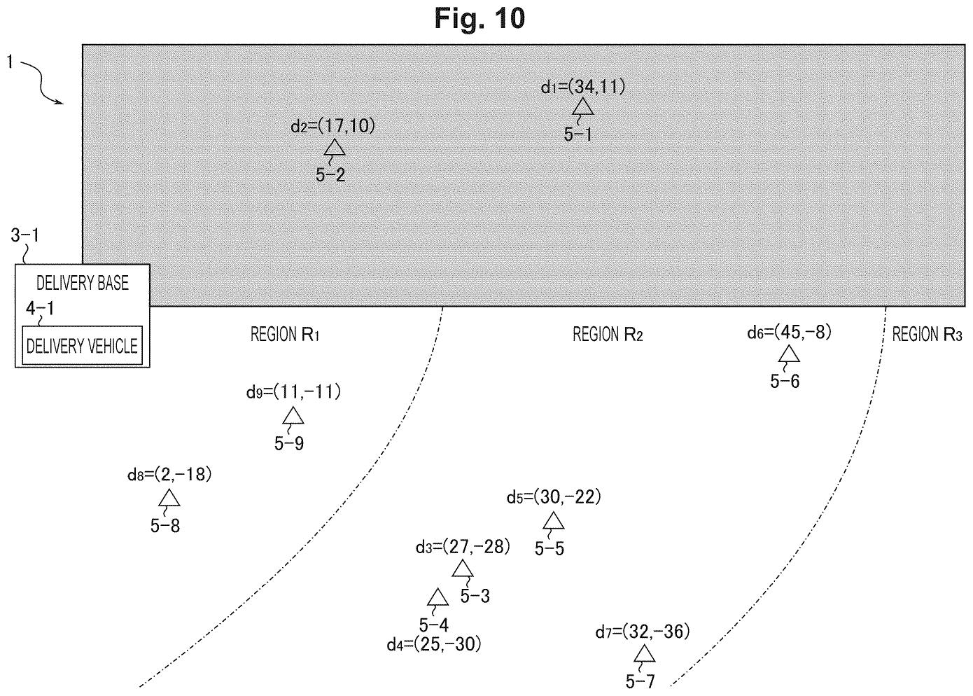

Furthermore, for example, in a case where the movement range is limited to the fourth quadrant in processing of S1 (S1; k=5), the classification unit 23 considers only delivery destinations 5-3 to 5-9 located in the fourth quadrant with respect to the delivery base 3-1 among the delivery destinations 5-1 to 5-9. As a result, as illustrated in FIG. 10, the classification unit 23 classifies the delivery destinations 5-8 and 5-9 into the region R₁ according to Formula (1) or (1)′. Furthermore, the classification unit 23 classifies remaining delivery destinations 5-3 to 5-7 into the region R₂ according to Formula (2). The classification unit 23 does not classify any delivery destination into the region R₃.

Accordingly, the probability calculation unit 24 calculates “1” as probabilities Pr (8) and Pr (9) of the delivery destinations 5-8 and 5-9 classified into the region R₁. Furthermore, the probability calculation unit 24 calculates probabilities Pr (3) to Pr (7) of the delivery destinations 5-3 to 5-7 classified into the region R₂. As a result, the expected value calculation unit 25 calculates an expected value N (1, 5)=5.06.

In a case where all the movement ranges have been selected (S5; yes), the determination unit 26 determines the maximum value of expected values and the corresponding movement range (S6). Specifically, in a case where the movement range is limited to the fourth quadrant, the determination unit 26 determines that the delivery vehicle 4-1 can be expected to deliver supplies to delivery destinations 5 of the largest number (5.06 points).

The output unit 27 outputs determination result by the determination unit 26 to a user (57).

Thus, the delivery support operation ends (end).

### 1.3 Effects According to Embodiment

According to the embodiment, the probability calculation unit 24 calculates probabilities Pr (1) to Pr (9) that the delivery vehicle 4-1 arrives at a plurality of respective target positions on the basis of positional relationships d₁ to d₉ between the departure position of the delivery vehicle 4-1 and the plurality of respective target positions and remaining fuel G₁ before the delivery vehicle 4 departs. The expected value calculation unit 25 calculates an expected value N (1, 1) of the number of target positions where the delivery vehicle 4-1 arrives on the basis of the calculated probabilities Pr (1) to Pr (9). As a result, the delivery support device 10 can support calculation of an approximate solution of a problem of delivering supplies to as many delivery destinations 5 as possible using as few delivery vehicles 4 as possible among a plurality of delivery vehicles 4 disposed in different delivery bases 3. Therefore, the delivery support center 2 can efficiently create a delivery plan.

Furthermore, the probability calculation unit 24 calculates probabilities for a case where there is no limitation on the movement range and a case where the movement range is limited to the fourth quadrant. On the Basis of the calculated probabilities, the expected value calculation unit 25 calculates an expected value N (1, 1) in a case where there is no limitation on the movement range and an expected value N (1, 5) in a case where the movement range is limited to the fourth quadrant. As a result, the delivery support device 10 can compare ranges and determine within which range the delivery vehicle 4-1 moves to deliver supplies to more delivery destinations 5. Therefore, the delivery support device 10 can accurately calculate the maximum value of expected values.

Furthermore, the output unit 27 outputs both the maximum expected value among the expected values calculated for respective movement ranges and the corresponding movement range. As a result, a user can grasp within which movement range the delivery vehicle 4-1 is moved to deliver supplies to more delivery destinations 5. Therefore, the delivery support device 10 can support creation of a more accurate delivery plan.

Furthermore, prior to calculation of probabilities by the probability calculation unit 24, the classification unit 23 classifies the plurality of target positions into one of the three regions R₁ to R₃ on the basis of the positional relationships d₁ to d₉ and the remaining fuel G₁ before the delivery vehicle 4 departs. Specifically, the classification unit 23 classifies a target position having a probability of 100% into the region R₁, classifies a target position having a probability of 0% into the region R₃, and classifies a target position having a probability that is larger than 0% and smaller than 100% into the region R₂. As a result, the probability calculation unit 24 can limit calculation processing of probabilities involving operations to target positions that belong to the region R₂. Therefore, the processing load in the probability calculation unit 24 can be reduced.

Furthermore, the classification unit 23 classifies target positions according to Formulas (1) to (3). The probability calculation unit 24 calculates probabilities according to Formula (4). The probabilities calculated in this manner do not depend on the action purpose of the delivery vehicle 4-1. In other words, the probabilities calculated by the probability calculation unit 24 are calculated in consideration of a case where the delivery vehicle 4-1 takes every action purpose in an assumed range. Therefore, the expected value calculation unit 25 can calculate expected values in consideration of a case where the delivery vehicle 4-1 moves on the basis of an action purpose other than a purpose of minimizing the moving distance. Therefore, the delivery support device 10 can support efficient creation of a delivery plan.

### 2. Others

Note that various modifications can be applied to the above-described embodiment.

For example, in the embodiment described above, a case where the delivery support program is performed by the delivery support device 10 in the delivery support center 2 has been described, but the present invention is not limited thereto. For example, the delivery support management program may be performed on a calculation resource on the cloud.

Furthermore, for example, in the above-described embodiment, a case where the movement range is divided into four quadrants has been described, but the present invention is not limited thereto. For example, the movement range information 22c may define any region in the delivery system 1 as a movement range.

Note that the present invention is not limited to the above embodiment, and various modifications can be made in the implementation stage without departing from the gist of the invention. Furthermore, each embodiment may be implemented in appropriate combination, and in that case, combined effects can be obtained. Furthermore, the embodiment described above includes various inventions, and various inventions can be extracted by a combination selected from a plurality of disclosed components. For example, even if some components are deleted from all the components described in the embodiment, in a case where the problem can be solved and the effects can be obtained, a configuration from which the components are deleted can be extracted as an invention.

### REFERENCE SIGNS LIST

1 Delivery system
2 Delivery support center
3-1, 3-2 Delivery base
4-1, 4-2 Delivery vehicle
5-1, 5-2, 5-3, 5-4, 5-5, 5-6, 5-7, 5-8, 5-9 Delivery destination
10 Delivery support device
11 Control circuit
12 Memory
13 Communication module
14 User interface
15 Drive
16 Storage medium
21 Input unit
22 Storage unit
22a Delivery vehicle information
22b Delivery destination information
22c Movement range information
23 Classification unit
24 Probability calculation unit
25 Expected value calculation unit
26 Determination unit
27 Output unit

1. A delivery support device comprising:
a probability calculation unit, implemented using one or more computing devices, configured to calculate probabilities that a delivery vehicle arrives at a plurality of respective target positions based on positional relationships between a departure position of the delivery vehicle and the plurality of respective target positions and an amount of fuel before the delivery vehicle departs; and
an expected value calculation unit, implemented using one or more computing devices, configured to calculate an expected value of a number of target positions where the delivery vehicle arrives based on probabilities for the plurality of respective target positions.

2. The delivery support device according to claim 1,
wherein the plurality of target positions are selected based on a movement range of the delivery vehicle,
wherein the probability calculation unit is configured to:
calculate a first probability based on a plurality of first target positions selected according to a first movement range, and
calculate a second probability based on a plurality of second target positions selected according to a second movement range different from the first movement range, and
wherein the expected value calculation unit is configured to calculate (i) a first expected value based on the first probability and (ii) a second expected value based on the second probability.

3. The delivery support device according to claim 2, further comprising:
an output unit, implemented using one or more computing devices, configured to output a maximum expected value among the first expected value and the second expected value with a corresponding movement range.

4. The delivery support device according to claim 1, further comprising:
a classification unit, implemented using one or more computing devices, configured to classify the plurality of target positions into any of a first region, a second region, and a third region based on the positional relationships and the amount of fuel,
wherein the probability calculation unit is configured to calculate, for a target position classified into the second region, a probability less than a probability calculated for a target position classified into the first region and greater than a probability calculated for a target position classified into the third region.

5. The delivery support device according to claim 4,
wherein the probability calculation unit is configured to:
calculate a probability of 100% for a target position classified into the first region,
calculate a probability less than 100% and greater than 0% for a target position classified into the second region, and
calculate a probability of 0% for a target position classified into the third region.

6. The delivery support device according to claim 1,
wherein the probability calculation unit is configured to calculate a probability that does not depend on an action purpose of the delivery vehicle.

7. A delivery support method comprising:
calculating probabilities that a delivery vehicle arrives at a plurality of respective target positions based on positional relationships between a departure position of the delivery vehicle and the plurality of respective target positions and an amount of fuel before the delivery vehicle departs; and
calculating an expected value of a number of target positions where the delivery vehicle arrives based on probabilities for the plurality of respective target positions.

8. A non-transitory computer recording medium storing a delivery support program, wherein execution of the delivery support program causes one or more computers to perform operations comprising:
calculating probabilities that a delivery vehicle arrives at a plurality of respective target positions based on positional relationships between a departure position of the delivery vehicle and the plurality of respective target positions and an amount of fuel before the delivery vehicle departs; and
calculating an expected value of a number of target positions where the delivery vehicle arrives based on probabilities for the plurality of respective target positions.
